(19) United States
(12) Patent Application Publication
(10) Pub. No.: US 2024/0364807 A1
(43) Pub. Date: Oct. 31, 2024

(54) REDUNDANT DEVICE USAGE OPTIMIZATION IN A GEO-FENCED CONTEXTUALLY AWARE NETWORK

(71) Applicant: International Business Machines Corporation, Armonk, NY (US)

(72) Inventors: Hemant Kumar Sivaswamy, Pune (IN); Shikhar Kwatra, San Jose, CA (US); Tiberiu Suto, Franklin, NY (US); RAJESH KUMAR JEYAPAUL, Bangalore (IN)

(21) Appl. No.: 18/307,841

(22) Filed: Apr. 27, 2023

(51) Int. Cl. H04M 1/72463; H04M 1/72457

(52) U.S. Cl. CPC H04M 1/72463; H04M 1/72457

(57) ABSTRACT

A processor may identify that there is a disruption in an environment. The processor may converge a group of two or more devices. The group of two or more devices may be converged in a geofenced area. The processor may limit the usage of the group of the two or more devices to the usage of one of the two or more devices at a time.

### BACKGROUND

The present disclosure relates generally to the field of the Internet-of-Things (IoT), and more specifically to identifying a disruption in an environment and optimizing devices within the environment until the disruption ceases.

During wide-spread extended power outages in an emergency such as floods, storms, etc., it can be important to conserve the battery power of mobile phones since it can take a significant amount of time before power is restored and phones can be plugged in to be recharged. Conserving power can ensure that users are able to communicate to the rest of the world for food, medicine and any other emergency requests for evacuation, etc.

### SUMMARY

Embodiments of the present disclosure include a method, computer program product, and system for redundant device usage optimization in a geofenced contextually aware network. A processor may identify that there is a disruption in an environment. The processor may converge a group of two or more devices. The group of two or more devices may be converged in a geofenced area. The processor may limit the usage of the group of the two or more devices to the usage of one of the two or more devices at a time.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a block diagram illustrating an embodiment of a computer system and the components thereof, upon which embodiments described herein may be implemented in accordance with the present disclosure.

FIG. 2 depicts a block diagram illustrating an extension of the computing system environment of FIG. 1, wherein the computer systems are configured to operate in a network environment (including a cloud environment), and perform methods described herein in accordance with the present disclosure.

FIG. 3A illustrates a block diagram of an example network of devices in an environment, in accordance with aspects of the present disclosure.

FIG. 3B illustrates a block diagram of an example network of geo-fenced environments, in accordance with aspects of the present disclosure.

FIG. 3C illustrates a block diagram of an example device with contextual awareness, in accordance with aspects of the present disclosure.

FIG. 3D illustrates a block diagram of an example environment of limited devices, in accordance with aspects of the present disclosure.

FIG. 4 illustrates a flowchart of an example method for redundant device usage optimization in a geofenced contextually aware network, in accordance with aspects of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of the Internet-of-Things (IoT), and more specifically to identifying a disruption in an environment and optimizing devices within the environment until the disruption ceases. While the present disclosure is not necessarily limited to such applications, various aspects of the disclosure may be appreciated through a discussion of various examples using this context.

During wide-spread extended power outages in an emergency such as floods, storms, etc., it can be important to conserve the battery power of devices (e.g., mobile phones, tablets, smartwatches, etc.) since it can take a significant amount of time before power is restored and phones can be plugged in to be recharged. Conserving power can ensure that users are able to communicate to the rest of the world for food, medicine and any other emergency requests for evacuation, etc.

Accordingly, in instances where multiple devices are situated in a geo-fenced area, disclosed herein is a solution that can effectively allow users of said devices to multiply the amount of time available on their devices while allowing all the users to make or receive emergency messages (e.g., calls, texts, etc.).

As will be discussed more fully below, said solution disclosed herein may be a system, method, and/or computer program product for bringing/creating convergence of a group of device (e.g., mobile phone) users to a (pre-) defined geo-fence (e.g., a house, a building, a neighborhood, etc.) in order to prolong the usage of devices to the maximum extent during power outage situations (e.g., a disruption) due to natural calamity.

In some embodiments, each of the devices cumulatively adds life of each other device such that each device gets the life of all the phones participating in the geo-fenced network, that is, at any point only one device may be in use. For example, if there are 10 mobile phones in a geo-fenced network. Assume, each of the mobile phones will have a variable charge capacity of around 8 hrs. Thus, the capacity of each mobile phone usage is enhanced to 80 hrs cumulatively (8*10) with the disclosed methodology.

In some embodiments, the usage of the device(s) may follow a flexible policy, where a device with the highest energy/battery power in the network/geo-fenced area/environment is used first until it reaches an equilibrium with a next/other device, and then the device with the next highest energy is given preference (e.g., is made a main/primary/first device for usage).

In some embodiments, the solution disclosed herein may be blockchain backed, which may provide a seamless and reversible identity transfer of a device onto another device for a temporary emergency use while maintaining security (e.g., a first device, after hitting equilibrium [an equal battery power level] with another device may transfer it settings to the other device and so as to have the other device act like the first device).

Before turning to the FIGS. it is noted that various aspects of the present disclosure are described by narrative text, flowcharts, block diagrams of computer systems and/or block diagrams of the machine logic included in computer program product (CPP) embodiments. With respect to any flowcharts (depending upon the technology involved) the operations can be performed in a different order than what is shown in the flowchart. For example, two operations shown in successive flowchart blocks may be performed in reverse order, as a single integrated step, concurrently, or in a manner at least partially overlapping in time. A computer program product embodiment (“CPP embodiment”) is a term used in the present disclosure that may describe any set of one or more storage media (or “mediums”) collectively included in a set of one or more storage devices. The storage media may collectively include machine readable code corresponding to instructions and/or data for performing computer operations. A “storage device” may refer to any tangible hardware or device that can retain and store instructions for use by a computer processor. Without limitation, the computer readable storage medium may include an electronic storage medium, a magnetic storage medium, an optical storage medium, an electromagnetic storage medium, a semiconductor storage medium, a mechanical storage medium, and/or any combination thereof. Some known types of storage devices that include mediums referenced herein may include a diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination thereof. A computer-readable storage medium should not be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As understood by those skilled in the art, data is typically moved at some occasional points in time during normal operations of a storage device, such as during access, de-fragmentation or garbage collection, but this does not render the storage device as transitory because the data is not transitory while it is stored.

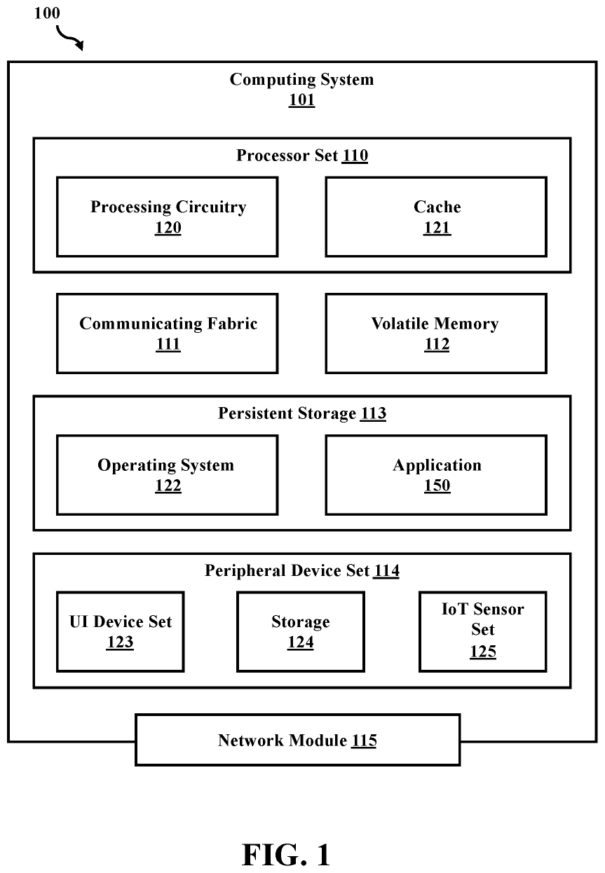

Referring now to FIG. 1, illustrated is a block diagram describing an embodiment of a computing system 101 within in a computing environment, which may be a simplified example of a computing device (i.e., a physical bare metal system and/or a virtual system) capable of performing the computing operations described herein. Computing system 101 may be representative of the one or more computing systems or devices implemented in accordance with the embodiments of the present disclosure and further described below in detail. It should be appreciated that FIG. 1 provides only an illustration of one implementation of a computing system 101 and does not imply any limitations regarding the environments in which different embodiments may be implemented. In general, the components illustrated in FIG. 1 may be representative of an electronic device, either physical or virtualized, capable of executing machine-readable program instructions.

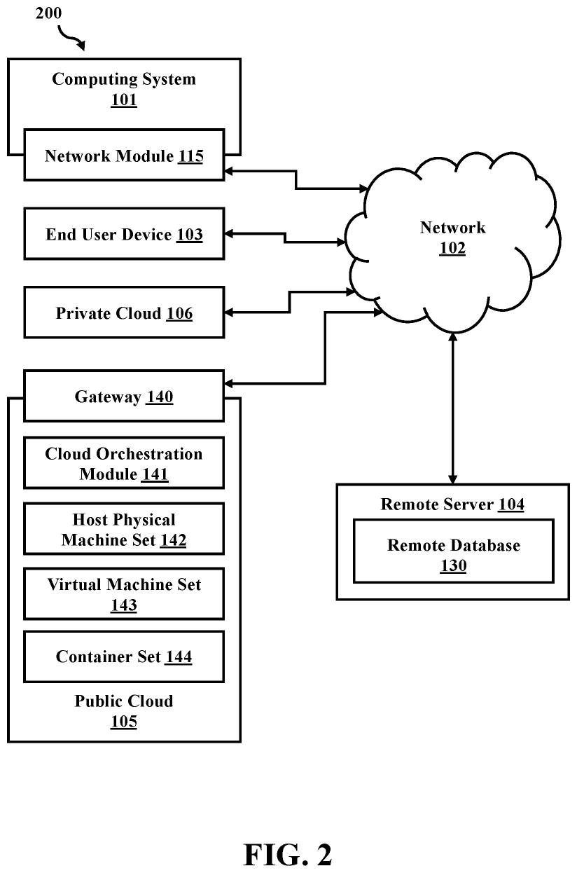

Embodiments of computing system 101 may take the form of a desktop computer, laptop computer, tablet computer, smart phone, smart watch or other wearable computer, mainframe computer, server, quantum computer, a non-conventional computer system such as an autonomous vehicle or home appliance, or any other form of computer or mobile device now known or to be developed in the future that is capable of running a program 150, accessing a network 102 or querying a database, such as remote database 130. Performance of a computer-implemented method executed by a computing system 101 may be distributed among multiple computers and/or between multiple locations. Computing system 101 may be located as part of a cloud network, even though it is not shown within a cloud in FIGS. 1-2. Moreover, computing system 101 is not required to be in a cloud network except to any extent as may be affirmatively indicated.

Processor set 110 includes one, or more, computer processors of any type now known or to be developed in the future. Processing circuitry 120 may be distributed over multiple packages. For example, multiple, coordinated integrated circuit chips. Processing circuitry 120 may implement multiple processor threads and/or multiple processor cores. Cache 121 may refer to memory that is located on the processor chip package(s) and/or may be used for data or code that can be made available for rapid access by the threads or cores running on processor set 110. Cache 121 memories can be organized into multiple levels depending upon relative proximity to the processing circuitry 120. Alternatively, some, or all of cache 121 of processor set 110 may be located “off chip.” In some computing environments, processor set 110 may be designed for working with qubits and performing quantum computing.

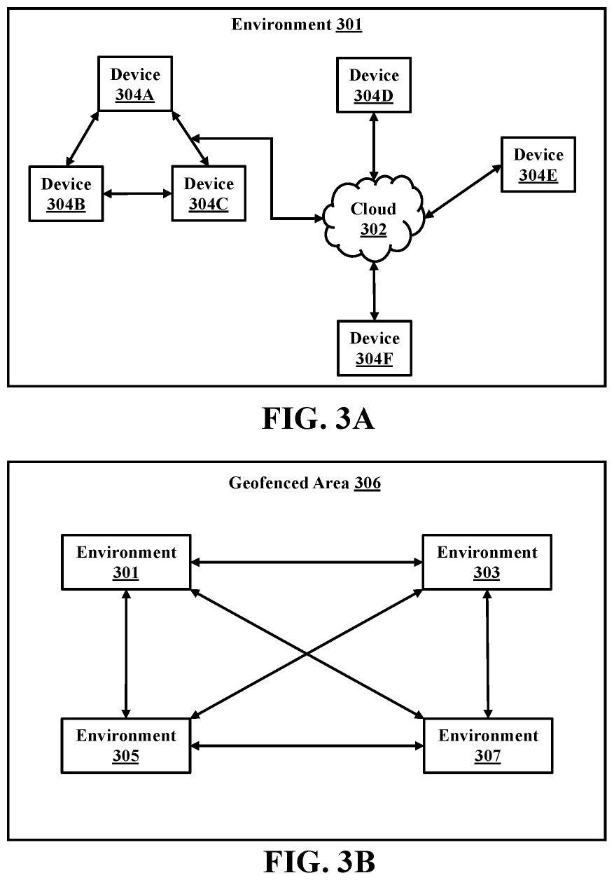

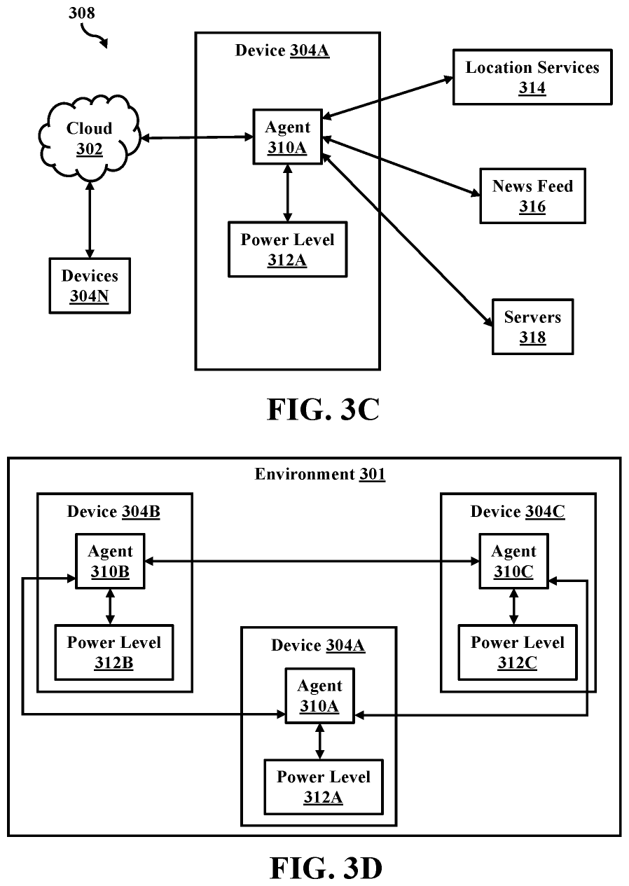

Computer readable program instructions can be loaded onto computing system 101 to cause a series of operational steps to be performed by processor set 110 of computing system 101 and thereby implement a computer-implemented method. Execution of the instructions can instantiate the methods specified in flowcharts and/or narrative descriptions of computer-implemented methods included in this specification (collectively referred to as “the inventive methods”). The computer readable program instructions can be stored in various types of computer readable storage media, such as cache 121 and the other storage media discussed herein. The program instructions, and associated data, can be accessed by processor set 110 to control and direct performance of the inventive methods. In computing environments of FIGS. 1-2, at least some of the instructions for performing the inventive methods may be stored in persistent storage 113, volatile memory 112, and/or cache 121, as application(s) 150 comprising one or more running processes, services, programs and installed components thereof. For example, program instructions, processes, services and installed components thereof may include the components and/or sub-components of the system 300 as shown in FIG. 3.

Communication fabric 111 may refer to signal conduction paths that may allow the various components of computing system 101 to communicate with each other. For example, communications fabric 111 can provide for electronic communication among the processor set 110, volatile memory 112, persistent storage 113, peripheral device set 114 and/or network module 115. Communication fabric 111 can be made of switches and/or electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 may refer to any type of volatile memory now known or to be developed in the future, and may be characterized by random access, but this is not required unless affirmatively indicated. Examples include dynamic type random access memory (RAM) or static type RAM. In computing system 101, the volatile memory 112 is located in a single package and can be internal to computing system 101, but, alternatively or additionally, the volatile memory 112 may be distributed over multiple packages and/or located externally with respect to computing system 101. Application 150, along with any program(s), processes, services, and installed components thereof, described herein, may be stored in volatile memory 112 and/or persistent storage 113 for execution and/or access by one or more of the respective processor sets 110 of the computing system 101.

Persistent storage 113 can be any form of non-volatile storage for computers that may be currently known or developed in the future. The non-volatility of this storage means that the stored data may be maintained regardless of whether power is being supplied to computing system 101 and/or directly to persistent storage 113. Persistent storage 113 may be a read only memory (ROM), however, at least a portion of the persistent storage 113 may allow writing of data, deletion of data and/or re-writing of data. Some forms of persistent storage 113 may include magnetic disks, solid-state storage devices, hard drives, flash-based memory, erasable read-only memories (EPROM) and semi-conductor storage devices. Operating system 122 may take several forms, such as various known proprietary operating systems or open-source Portable Operating System Interface type operating systems that employ a kernel.

Peripheral device set 114 includes one or more peripheral devices connected to computing system 101. For example, via an input/output (I/O interface). Data communication connections between the peripheral devices and the other components of computing system 101 may be implemented using various methods. For example, through connections using Bluetooth, Near-Field Communication (NFC), wired connections or cables (such as universal serial bus (USB) type cables), insertion type connections (for example, secure digital (SD) card), connections made though local area communication networks and/or wide area networks such as the internet. In various embodiments, UI device set 123 may include components such as a display screen, speaker, microphone, wearable devices (such as goggles, headsets and smart watches), keyboard, mouse, printer, touchpad, game controllers, and haptic feedback devices. Storage 124 can include external storage, such as an external hard drive, or insertable storage, such as an SD card. Storage 124 may be persistent and/or volatile. In some embodiments, storage 124 may take the form of a quantum computing storage device for storing data in the form of qubits. In some embodiments, networks of computing systems 101 may utilize clustered computing and components acting as a single pool of seamless resources when accessed through a network by one or more computing systems 101. For example, a storage area network (SAN) that is shared by multiple, geographically distributed computer systems 101 or network-attached storage (NAS) applications. IoT sensor set 125 can be made up of sensors that can be used in Internet-of-Things applications. For example, a sensor may be a temperature sensor, motion sensor, infrared sensor or any other type of known sensor type.

Network module 115 may include a collection of computer software, hardware, and/or firmware that allows computing system 101 to communicate with other computer systems through a network 102, such as a LAN or WAN. Network module 115 may include hardware, such as modems or Wi-Fi signal transceivers, software for packetizing and/or de-packetizing data for communication network transmission, and/or web browser software for communicating data over the network. In some embodiments, network control functions and network forwarding functions of network module 115 are performed on the same physical hardware device. In other embodiments (for example, embodiments that utilize software-defined networking (SDN)), the control functions and the forwarding functions of network module 115 can be performed on physically separate devices, such that the control functions manage several different network hardware devices. Computer readable program instructions for performing the inventive methods can typically be downloaded to computing system 101 from an external computer or external storage device through a network adapter card or network interface included in network module 115.

Continuing, FIG. 2 depicts a computing environment 200 which may be an extension of the computing environment 100 of FIG. 1, operating as part of a network. In addition to computing system 101, computing environment 200 can include a network 102 such as a wide area network (WAN) (or another type of computer network) connecting computing system 101 to an end user device (EUD) 103, remote server 104, public cloud 105, and/or private cloud 106. In this embodiment, computing system 101 includes processor set 110 (including processing circuitry 120 and cache 121), communication fabric 111, volatile memory 112, persistent storage 113 (including operating system 122 and program(s) 150, as identified above), peripheral device set 114 (including user interface (UI), device set 123, storage 124, Internet of Things (IoT) sensor set 125), and network module 115. Remote server 104 includes remote database 130. Public cloud 105 includes gateway 140, cloud orchestration module 141, host physical machine set 142, virtual machine set 143, and/or container set 144.

Network 102 may be comprised of wired or wireless connections. For example, connections may be comprised of computer hardware such as copper transmission cables, optical transmission fibers, wireless transmission, routers, firewalls, switches, gateway computers and/or edge servers. Network 102 may be described as any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. Other types of networks that can be used to interconnect the various computer systems 101, end user devices 103, remote servers 104, private cloud 106 and/or public cloud 105 may include Wireless Local Area Networks (WLANs), home area network (HAN), backbone networks (BBN), peer to peer networks (P2P), campus networks, enterprise networks, the Internet, single tenant or multi-tenant cloud computing networks, the Public Switched Telephone Network (PSTN), and any other network or network topology known by a person skilled in the art to interconnect computing systems 101.

End user device 103 can include any computer device that can be used and/or controlled by an end user (for example, a customer of an enterprise that operates computing system 101) and may take any of the forms discussed above in connection with computing system 101. EUD 103 may receive helpful and useful data from the operations of computing system 101. For example, in a hypothetical case where computing system 101 is designed to provide a recommendation to an end user, this recommendation may be communicated from network module 115 of computing system 101 through WAN 102 to EUD 103. In this example, EUD 103 can display, or otherwise present, the recommendation to an end user. In some embodiments, EUD 103 may be a client device, such as thin client, thick client, mobile computing device such as a smart phone, mainframe computer, desktop computer and so on.

Remote server 104 may be any computing systems that serves at least some data and/or functionality to computing system 101. Remote server 104 may be controlled and used by the same entity that operates computing system 101. Remote server 104 represents the machine(s) that collect and store helpful and useful data for use by other computers, such as computing system 101. For example, in a hypothetical case where computing system 101 is designed and programmed to provide a recommendation based on historical data, the historical data may be provided to computing system 101 from remote database 130 of remote server 104.

Public cloud 105 may be any computing systems available for use by multiple entities that provide on-demand availability of computer system resources and/or other computer capabilities including data storage (cloud storage) and computing power, without direct active management by the user. The direct and active management of the computing resources of public cloud 105 can be performed by the computer hardware and/or software of cloud orchestration module 141. The computing resources provided by public cloud 105 can be implemented by virtual computing environments that run on various computers making up the computers of host physical machine set 142, and/or the universe of physical computers in and/or available to public cloud 105. The virtual computing environments (VCEs) may take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through network 102.

VCEs can be stored as “images.” A new active instance of the VCE can be instantiated from the image. Two types of VCEs may include virtual machines and containers. A container is a VCE that uses operating-system-level virtualization, in which the kernel allows the existence of multiple isolated user-space instances, called containers. These isolated user-space instances may behave as physical computers from the point of view of programs 150 running in them. An application 150 running on an operating system 122 can utilize all resources of that computer, such as connected devices, files and folders, network shares, CPU power, and quantifiable hardware capabilities. Applications 150 running inside a container of container set 144 may only use the contents of the container and devices assigned to the container, a feature which may be referred to as containerization.

Private cloud 106 may be similar to public cloud 105, except that the computing resources may only be available for use by a single enterprise. While private cloud 106 is depicted as being in communication with network 102 (such as the Internet), in other embodiments a private cloud 106 may be disconnected from the internet entirely and only accessible through a local/private network. A hybrid cloud may refer to a composition of multiple clouds of different types (for example, private, community or public cloud types), and the plurality of clouds may be implemented or operated by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 may be both part of a larger hybrid cloud environment.

Referring now to FIG. 3A, illustrated is a block diagram of an example network of devices 304A-F in an environment 301, in accordance with aspects of the present disclosure.

As depicted, the network includes the environment 301, cloud 302, and devices 304A-F. In some embodiments, the environment 301 is a household where the devices 304A-F are made “ready” for contextually aware processing. In some embodiments, the devices 304A-F are connected via the cloud 302. In some embodiments, the environment 301 may be any area that is geo-fenced (e.g., a neighborhood, an apartment building, etc.) after a disruption is identified/determined. It is noted that like reference numerals are used to designate like parts in the accompanying FIGS.

As depicted, a cluster of devices 302A-C may intercommunicate with one another, but after the determinization of a disruption, any available device 302D-F may be utilized to help users communicate outside of the environment 301 (e.g., devices 302A-C may be smartphones that are utilized at the beginning of a disruption, but device 302D may be a laptop that is utilized as a last viable communication option once the power levels of the devices 302A-C reach a nominal level).

Referring now to FIG. 3B, illustrated is a block diagram of an example network of geo-fenced area 306 environments 301, 303, 305, and 307, in accordance with aspects of the present disclosure. In some embodiments, the network may be the same network as in FIG. 3A. As depicted, the geo-fenced area 306 includes the environment 301 of FIG. 3A, environment 303, environment 305, and environment 307. In some embodiments, while not depicted, each of the environments 301, 303, 305, and 307 may each include one or more devices that allow the environments 301, 303, 305, and 307 to communicate. In some embodiments, each of the environments 301, 303, 305, and 307 may be a device.

In some embodiments, after a disruption (e.g., natural calamity) is identified, each of the environments 301, 303, 305, and 307 may be geo-fenced together by the geo-fenced area 306, which may have been pre-defined before any disruption, or impromptu based on devices that are available in each area. Regardless of embodiment, the environments 301, 303, 305, and 307 (or devices 302A-F) may only communicate with one another after a disruption via opting into such communication.

In some embodiments, as depicted, the geo-fencing of the environments 301, 303, 305, and 307 in the geo-fenced area 306 allow the environments 301, 303, 305, and 307 to communicate with one another during a disruption and provide information about the disruption and their users in each environment 301, 303, 305, and 307 to one another; which may help in relief efforts.

Referring now to FIG. 3C, illustrated is a block diagram of an example device 304A with contextual awareness 308, in accordance with aspects of the present disclosure.

As depicted, the device 304A includes an agent 310A and a power level 312A. Further, as depicted, the device 304A via the agent 310A, is in communication with cloud 302, devices 304N (which may be an aggregate of the one or more of the devices 304A-F of FIG. 3A), locations services 314, news feed 316, and servers 318. In some embodiments, the communication between the agent 310A and each of the components 302, 304N, 314, 316, and 318 allow the device 304A to maintain contextual awareness 308 (e.g., the ability to gather information about its surroundings).

In some embodiments, the agent 310A is installed on the device 304A to make the device 304A ready for any disruptions/emergencies. The device 304A, via the agent 310A communicating with cloud 302 is then connected with the devices 304N, where the devices 304N are a part of a geo-fenced area, or a predefined network (e.g., all the devices 304N are within a house). In some embodiments, the device 304A communicates with the devices 304N via their own installed agent 310A, and in some embodiments the device 304A communicates with the devices 304N to determine if a disruption is actually affecting the user (e.g., devices 304N are smart home appliances that are not portable and the device 304A tries to communicate with devices 304N to determine if power is out at the user's house, etc.).

In some embodiments, the location services 314 may be utilized by the agent 310A for context of a disruption (e.g., there was a lightning strike 3 miles away, there is hail in the immediate area in relation to the device 304A, etc.).

In some embodiments, the agent 310A receives information about the disruption from the news feed 316, and relays said information to the device 304A for use by a user. In some embodiments, servers 318, which may be mobile backend servers, can be used for: sending disruption information from the device 304A via the agent 310A, or receiving disruption information (e.g., such as from a national service, etc.).

In some embodiments, the power level 312A is associated with the battery life left on the device 304A and the power level 312A may help the agent 310A in determining if, when, and which other devices 304N or components 314, 316, and 318 the device 304A is to communicate with. For example, if the power level 312A is near 100% the agent 310A may communicate with each of the cloud 302, the location services 314, the news feed 316, and the servers 318 in order to provide and receive up-to-date disruption information. Whereas, if the power level 312A is 10%, the agent 310A may only communicate with news feed 316 in order to keep the user up to date about the whereabouts of the disruption.

Referring now to FIG. 3D, illustrated is a block diagram of an example environment 301 of limited devices 304-C, in accordance with aspects of the present disclosure. As depicted, each of the devices 304A-C includes a respective agent 310A-C and respective power level 312A-C.

In some embodiments, if a disruption in the environment 301 (e.g., near a user's home, in a certain county, etc.) is identified by any of the agents 310A-C, each agent 310A-C analyzes the respective power levels 312A-C on each of their respective devices 304A-C. The agents 310A-C then communicate the power levels 312A-C to each of the other agents 310A-C. In some embodiments, one of the agents 310A-C may be designated as a lead agent to make all decisions or analyses.

In some embodiments, the agents 310A-C identify which device 304A-C has the highest power level 312A-C and the device 304A-C with the highest power level 312A-C (e.g., longest battery life) is designated as a main device for communication for all of the devices 304A-C (e.g., device 304A has the longest battery life and therefore is chosen to have its device functionalities remained intact, whereas devices 304B and 304C have their functionalities limited [e.g., background processes halted, power saving mode, etc.]). In some embodiments, the main functions of the limited devices (e.g., 304B and 304C) are forwarded to the main device (e.g., 304A). For example, calls from devices 304B and 304C are forwarded to device 304A to handle the calls. In some embodiments, once the first/main device (e.g., 304A) has its power level drop below an equilibrium in regard to the other devices (e.g., 304B and 304C), another device (e.g., 304B and 304C) is designated as the first/main device and the original first/main device (e.g., 304A) has its functionalities limited.

As an in-depth example, assume an alert (from the news feed 316) about a flood is received by a smart phone (e.g., device 304A) or smart phones (e.g., devices 304A-C) in a particular area (e.g., environment 301). Now assume there are three smart phones (e.g., devices 304A-C) in a single house, the three smart phones are then geo-fenced together to form a home mobile network associated with that single house. Each smart phone then checks with contextual IoT devices (e.g., outdoor sensors, other devices' sensors, etc.) in the particular area or other geo-fenced areas to determine if power has been lost to the particular area or other geo-fenced areas.

If power has not been lost, each smart phone alerts its user to recommend/suggest charging the smart phones. If, however, power has been lost, each smart phone within the geo-fenced area communicates to identify the smart phone with the maximum power. The smart phone with the maximum power is left powered on, but put in a low energy consumption mode and deemed the first/main smart phone, while the other smart phones are put to rest/sleep mode. The smart phone with the maximum power left is then considered the first/main smart phone and is allowed to operate, while the other smart phones rest. It is noted that for such solution to be utilized herein, a user of a device will opt-in to such solution (e.g., opt in to allowing an agent on their device, the changing/limiting of functionalities, etc.). It is further noted that every user has the ability to manually override the functions automatically implemented on their device (e.g., if a smart phone is put to rest, a user can wake the smart phone back up and continue to use the smart phone normally).

Furthering the example, assume an agent module (e.g., 310A) is responsible for communicating with the other two smart phones, which are installed with their own agents (e.g., 310B and 310C. As the first/main smart phone is about to get discharged completely (e.g., about 2% batter life left), it communicates via its agent to the second most charged smart phone (e.g., device 304B) and brings the second most charged smart phone up to date with information as the first/main smart phone is put to rest. In some embodiments, while a smart phone is a main smart phone, it can store information (e.g., location data, call logs, etc.) on a blockchain backed system that then allows the information to be passed to the other smart phones as the other smart phones become the ‘main’ smart phones. Finishing the above example, likewise, when the second smart phone is also about to get discharged completely, it, via its agent, notifies the third smart phone (e.g., 304C) and goes to sleep; with the third smart phone now the main smart phone.

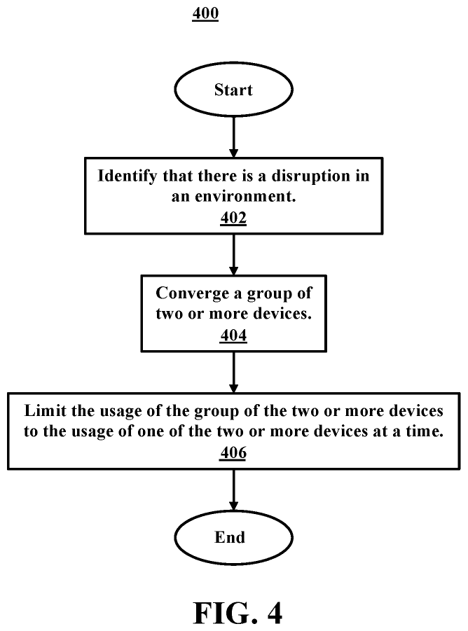

In some embodiments, the solution disclosed throughout and particularly in regard to FIGS. 3A-4 may generate/create a neighborhood network for mobile devices/phones. This could be based on a registration where the final registry is maintained @ server or through mobile phones/devices connected to similar WiFi network or LoraWAN network.

Further, an agent's (e.g., 310A-C) function may be to decide the first (e.g., main/primary/active) device among a group of devices in a defined network, environment, or geofenced area. The agent brings up the first device, interacts with all the other devices, keeps monitoring the charge capacity of the other devices in real time and switches the role of first/main from device to device to maintain longevity of the devices, collectively.

In some embodiments, upon receiving information such as a calamity in an area, the device owners are strongly advised via a notification on their devices to keep their devices charged at/to 100%. In some embodiments, the is notification is determined to be sent via an agent after the agent as analyzed one or all of a newsfeed (e.g., 316), weather application, etc.

In some embodiments, the agents of the devices check with the contextual IoT devices whether a power supply is ON (e.g., a power supply to a house, a neighborhood, a general area, etc.) and suggests for charging the devices to the fullest. In some embodiments, a device or smart phone is part of the home automation system (e.g., environment or geofenced area) where all the IoT devices are connected. When one of the IoT home systems (e.g., a smart TV, a smart washer/dryer, etc.) which are connected to the main plug goes off, the solution disclosed herein (e.g., home automation system) understands that there is a power supply failure. An agent then identifies the power failure (e.g., disruption), and the agent will then pick a first device based on the maximum energy available in the device and which has the capacity to survive long with minimal operational requirement applications like calling, SMS options, etc.

In some embodiments, a backend server (e.g., 318) will decide on the first phone using defined rules/protocols defined. In some embodiments, the rules/protocols will be predefined/preconfigured. For example, if all devices in the same network are at 100% charge, one of them will be selected randomly by the backend server as the first phone. If all devices are at different charge levels, the one with the highest charge will be assigned the first phone. All the other devices in the network are put to doze/sleep mode by the backend server. In some embodiments, before getting into doze mode, the backend server will inform the details of the first device.

In some embodiments, any further calls/texts/correspondences to the other devices/phones get routed to the first device, and will be kept in doze mode only. The backend server maintains the latest status of all the devices in the network (e.g., geo-fenced area, house, neighborhood, etc.). In some embodiments, there are situations where the devices which are in doze mode have to be switched on manually to make emergency calls. In this case, the role of the device is reversed where the recently switched on dozed device will become the ‘first’/main/active/primary phone and the actual current first phone is put to doze mode by an agent.

For example, assume there are four (4) phones in the network with charges of each phones as: A=90%, B=70%, C=60%, D=40%. The moment the power goes off in an environment/area, the agents of each of the phones gets activated. The backend server comes to know of the charge of each of the phones through their agents and the phone with the maximum battery energy, A, stays awake and the rest of the phones are put in doze mode.

Until the charge of A drains down to match the next phone with an equivalent charge, i.e., it hands over the control to B which has 70%. Now, both A and B are at 70%. Phone B continues to discharge since B is the active phone, until it reaches 60%. Now B and C are at 60% and A is at 70%. A becomes the active phone again until it discharges to 60%. The control is handed out this way until each of the phones drains out completely.

In some embodiments, the backend server communicates with the agents of each phone and tracks the phone charges, and decides the control of the first phone based on the battery charge. In this way, the devices in the network will get maximum energy sustainability during the critical time. At any given time the charge for each phone is the cumulative battery power of each phone. In the cited example, the charges for each phone is: A=90%, B=70%, C=60%, D=40%, thus assuming each phone gives an average of 8 hours for a full charge, the duration for each of the phones would be 90% of 8 hours+70% of 8 hours+60% of 8 hours+40% of 8 hours=7.2+5.6+4.8+3.2=20.8 hours.

In another example, news about power going off is received. The phones in the network are then prompted via their agent to provide the user a manual charge notification, and a user may decide to manually charge their phone/device(s). In such an embodiment, the phone supply goes off which is identified by the charging phones(s). If there is a disruption to the charging of the phone(s), this alerts the agent(s) in the phone(s) and one of the phones comes up as the first/main/active phone.

Continuing the example, the first phone is reachable (e.g., in a same wing or floor in an apartment) by a user, and people in the network will be depending on the first phone for external communication. In another scenario, some of the phones are physically cut off within the geofenced area (e.g., possibly across the wing/opposite street) and one of those phones have to make an emergency call while the first phone is active. In such a scenario, the second phone can initiate a call and, in the process, becomes the “first” phone. The other phone (which was the first phone until then) will go to doze mode. Once the phone call is done, the agent initializes again to check which phone has the maximum battery power and that phone is made the “first” phone.

In the above embodiment, a dynamic handshake occurs simultaneously using Adhoc based information stream fetch going into streams data. The information processed in the streams is passed to a discovery engine where a natural language understanding (NLU) algorithm is running in the backend. The information fetched based on intent and entities extracted are fed to a multi-label classifier which predicts the likelihood of the phones going out of network and appending said information with battery consumption in a JSON format, for instance:

Phone_json:
{ Ph_ID : 0x2353,
News: IBM_streams-output
Classifier: 0.7,
Battery: 20%,
Network: Sprinter,
Scatternet Pairing: Null (Not Initiated)}.

As soon as the above information is fetched, a scatternet pairing is initiated by going into system setting, calling os.systime function and polling a Bluetooth scatternet pairing trigger to be activated. A handshake is then initiated and an append function is called to add to the Scatternet pairing json of the initial phone identifier. The appended phone_2 ID gets added and further scatternet of approximately 12 devices are appended with their battery consumption and storage device_property attributes added to the pairing module with charge and network VOIP access being shared between said trusted devices in the proximal network. Such appending may look like:

Phone_json: {Timer 0xss};
{ Ph_ID : 0x2353,
News: IBM_streams-output
Classifier: 0.7,
Battery: 20%,
Network: Sprinter,
Scatternet Pairing: Devices_ID_Appended}.

The above process continues in case more devices which are part of the trusted network are identified and added to the network. For instance, as each house in a neighborhood has power restored, each house could have a device added to the network (geo-fenced area).

In some embodiments, participants/users opt into the disclosed solutions terms of use, and each participant registers their unique device ID unto a blockchain backed database accessible by the participants and the service provider.

When a participant needs to turn their phone off to conserve power, such as during an emergency power outage, the device will prompt for its identity to be transferred to another nearby device. The receiving device will display a QR code that will contain its identifier information and the amount of battery time left. Additionally the participant can input a pin code as part of the request. The pin code will be encrypted and required to “unlock” the identity on the receiving device in order to allow receiving or making any calls on the non-native device.

Once the request is authenticated and confirmed by user, the device sends a new record to the blockchain authorizing the temporary identity transfer to the new device for the specified amount of time according to that device battery left. The service provider will be able to read this identity transfer request within the blockchain and will transparently route all incoming calls to the new device for the time the rule is in effect.

Incoming calls on the receiving device will show which user the call is for and the pin has to be keyed in order for the call to be picked up. If the pin is not keyed in within the normal ring time, the call is sent to voicemail.

To make outgoing calls on the non-native device, the user will select their identity from the ones available on the device, enter the respective pin code and then proceed to make the call as normal. The provider will automatically identify and process the call as if it was made from the user's native device, including caller ID that will be shown on call destination, it will be their own.

If at any time the original device that requested transfer comes back online, it will automatically send a “back online” notification to the blockchain and the identification transfer is instantly reversed allowing it now to receive and make calls natively.

Referring now to FIG. 4, illustrated is a flowchart of an example method 400 for redundant device usage optimization in a geofenced contextually aware network, in accordance with aspects of the present disclosure.

In some embodiments, the method 400 begins at operation 402, where the processor identifies that there is a disruption in an environment. The method 400 then proceeds to operation 404, where the processor converges (e.g., groups, intercommunicates, etc.) a group of two or more devices. The group of two or more devices are converged in a geofenced area. The method 400 then proceeds to operation 406, where the processor limits the usage of the group of the two or more devices to the usage of one of the two or more devices at a time. In some embodiments, the method 400 may end.

In some embodiments, discussed below, there are one or more operations of the method 400 not depicted for the sake of brevity and which are discussed throughout this disclosure. Accordingly, in some embodiments, limiting the usage of the group of the two or more devices includes changing the modes of the two or more devices. In some embodiments, the group of the two or more devices follows a flexibility policy to limit the usage of the group of the two or more devices.

In some embodiments, the method 400 further comprises the processor determining, continually based on the flexibility policy, which first device of the group of the two or more devices has a longest battery life. In some embodiments, the first device with the longest battery life is not limited in usage.

In some embodiments, the method 400 further comprises the processor analyzing the first device with the longest battery life until the first device with the longest battery life reaches an equilibrium with at least one other device in the group of the two or more device.

In some embodiments, the method 400 further comprises the processor allowing usage of the at least one other device, and limiting usage of the first device with the longest battery life.

In some embodiments, the method 400 further comprises the processor transferring, via blockchain, an identity of the first device with the longest battery life to the at least one other device. In some embodiments, the identity of the first device is associated with all of the two or more devices in the group.

It is noted that the descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

What is claimed is:

1. A computer system for redundant device usage optimization in a geofenced contextually aware network, the computer system comprising:
one or more processors, one or more computer-readable memories and one or more computer-readable storage media;
program instructions, stored on at least one of the one or more storage media for execution by at least one of the one or more processors via at least one of the one or more memories, to identify that there is a disruption in an environment;
program instructions, stored on at least one of the one or more storage media for execution by at least one of the one or more processors via at least one of the one or more memories, to converge a group of two or more devices, wherein the group of two or more devices are converged in a geofenced area; and
program instructions, stored on at least one of the one or more storage media for execution by at least one of the one or more processors via at least one of the one or more memories, to limit the usage of the group of the two or more devices to the usage of one of the two or more devices at a time.

2. The computer system of claim 1, wherein limiting the usage of the group of the two or more devices includes changing the modes of the two or more devices.

3. The computer system of claim 1, wherein the group of the two or more devices follows a flexibility policy to limit the usage of the group of the two or more devices.

4. The computer system of claim 3, further comprising:
program instructions, stored on at least one of the one or more storage media for execution by at least one of the one or more processors via at least one of the one or more memories, to determine, continually based on the flexibility policy, which first device of the group of the two or more devices has a longest battery life, and wherein the first device with the longest battery life is not limited in usage.

5. The computer system of claim 4, further comprising:
program instructions, stored on at least one of the one or more storage media for execution by at least one of the one or more processors via at least one of the one or more memories, to analyze the first device with the longest battery life until the first device with the longest battery life reaches an equilibrium with at least one other device in the group of the two or more device.

6. The computer system of claim 5, further comprising:
program instructions, stored on at least one of the one or more storage media for execution by at least one of the one or more processors via at least one of the one or more memories, to allow usage of the at least one other device; and
program instructions, stored on at least one of the one or more storage media for execution by at least one of the one or more processors via at least one of the one or more memories, to limit usage of the first device with the longest battery life.

7. The computer system of claim 6, further comprising:
program instructions, stored on at least one of the one or more storage media for execution by at least one of the one or more processors via at least one of the one or more memories, to transfer, via blockchain, an identity of the first device with the longest battery life to the at least one other device, wherein the identity of the first device is associated with all of the two or more devices in the group.

8. A computer-implemented method for redundant device usage optimization in a geofenced contextually aware network, the method comprising:
identifying, by a processor, that there is a disruption in an environment;
converging a group of two or more devices, wherein the group of two or more devices are converged in a geofenced area; and
limiting the usage of the group of the two or more devices to the usage of one of the two or more devices at a time.

9. The method of claim 8, wherein limiting the usage of the group of the two or more devices includes changing the modes of the two or more devices.

10. The method of claim 8, wherein the group of the two or more devices follows a flexibility policy to limit the usage of the group of the two or more devices.

11. The method of claim 10, further comprising:
determining, continually based on the flexibility policy, which first device of the group of the two or more devices has a longest battery life, and wherein the first device with the longest battery life is not limited in usage.

12. The method of claim 11, further comprising:
analyzing the first device with the longest battery life until the first device with the longest battery life reaches an equilibrium with at least one other device in the group of the two or more device.

13. The method of claim 12, further comprising:
allowing usage of the at least one other device; and
limiting usage of the first device with the longest battery life.

14. The method of claim 13, further comprising:
transferring, via blockchain, an identity of the first device with the longest battery life to the at least one other device, wherein the identity of the first device is associated with all of the two or more devices in the group.

15. A computer program product for redundant device usage optimization in a geofenced contextually aware network, the computer system comprising:
one or more computer-readable storage media;
program instructions, stored on at least one of the one or more storage media, to identify that there is a disruption in an environment;
program instructions, stored on at least one of the one or more storage media, to converge a group of two or more devices, wherein the group of two or more devices are converged in a geofenced area; and
program instructions, stored on at least one of the one or more storage media, to limit the usage of the group of the two or more devices to the usage of one of the two or more devices at a time.

16. The computer program product of claim 15, wherein limiting the usage of the group of the two or more devices includes changing the modes of the two or more devices.

17. The computer program product of claim 15, wherein the group of the two or more devices follows a flexibility policy to limit the usage of the group of the two or more devices.

18. The computer program product of claim 17, further comprising:
program instructions, stored on at least one of the one or more storage media, to determine, continually based on the flexibility policy, which first device of the group of the two or more devices has a longest battery life, and wherein the first device with the longest battery life is not limited in usage.

19. The computer program product of claim 18, further comprising:
program instructions, stored on at least one of the one or more storage media, to analyze the first device with the longest battery life until the first device with the longest battery life reaches an equilibrium with at least one other device in the group of the two or more device.

20. The computer program product of claim 19, further comprising:
program instructions, stored on at least one of the one or more storage media, to allow usage of the at least one other device; and
program instructions, stored on at least one of the one or more storage media, to limit usage of the first device with the longest battery life.
